(19) United States
(12) Patent Application Publication
(10) Pub. No.: US 2019/0233981 A1
(43) Pub. Date: Aug. 1, 2019

(54) Ring Traveler

(71) Applicant: Bräcker AG, Pfäffikon-Zürich (CH)

(72) Inventors: Markus Dippel, Pfäffikon (CH); Birgit Pedimonte, Uster (CH)

(21) Appl. No.: 16/318,721

(22) PCT Filed: Jun. 29, 2017
(86) PCT No.: PCT/IB2017/053909

§ 371 Date: Jan. 18, 2019

(30) Foreign Application Priority Data
Jul. 22, 2016 (CH) 00948/16

(51) Int. Cl. D01H 7/60; C09D 179/08; C10M 169/04

(52) U.S. Cl. CPC D01H 7/604; C09D 179/08; C10M 169/04; C10M 2201/102; C10M 2201/05; C10M 2201/065; C10M 2201/085; C10M 2201/041

(57) ABSTRACT

The invention relates to a ring traveler (10) for ring spinning or ring twisting machines having a metallic core, wherein the metallic core is at least partially coated with an anti-friction coating consisting of at least a base polymer and a solid lubricant, whereby the anti-friction coating has a layer thickness of 0.1 μm to 50 μm and the base polymer is from the group of polyamides, polyimides, polyamide/imides.

The invention relates to a ring traveler for a ring spinning machine or a ring twisting machine as well as a ring spinning or twisting machine.

Ring travelers are used in so-called ring spinning machines or ring twisting machines, in which the ring travelers work together with the spinning rings and/or twisting rings on which they are placed. The ring travelers rotate at high speeds on the top side of the spinning rings, the so-called ring crown, having been entrained by the thread held by the ring traveler. This results in high loads on the contact surfaces of the ring travelers with the spinning rings. For this reason, the surface properties receive special attention when manufacturing spinning rings and ring travelers. A spinning ring for a ring spinning and/or ring twisting machine must have not only an accurate shape but also must have a surface optimized to adapt it to meet requirements in order to impart the smoothest possible running with the least possible wear to the ring traveler, which rotates at a high speed on the spinning ring. The dimensional stability and surface properties of the ring traveler are important for smooth running, on the one hand, and for trouble-free passage of the yarn, on the other hand. Due to the rapid rotation of the ring traveler on the spinning ring, temperatures of more than 400° C. may occur locally, constituting an additional requirement regarding the properties of the surfaces of ring travelers and spinning rings. Because of the loads and high wear resistance demands, spinning rings are made of metal and in most cases are provided with a heat treatment or a metallic coating.

Various methods for coating or treating the surfaces of ring travelers and/or spinning rings are known from the prior art. For example, WO 99/51802 describes the application of a hard chrome coating, for example. A hard chrome plating is applied to components in an electrolytic chrome plating process, usually for the purpose of preventing wear. U.S. Pat. No. 2,970,425 discloses a surface coating for a spinning ring with a chromium layer applied electrolytically. One disadvantage of this embodiment of hard chrome plating of a spinning ring is that, although it creates a hard, low-wear surface, the running properties of the ring traveler depend on a fiber lubricant film on the spinning ring and on the ring traveler surface. This film is created by yarn sliding through the ring traveler. However, this fiber lubricant film is established only after a certain period of operation.

Therefore, the object of the present invention is to improve upon the running properties, in particular the lubrication properties of the ring travelers in cooperation with the spinning rings in the initial phase of operation.

This object is achieved through the features of the independent claim. A ring traveler for ring spinning machines or ring twisting machines having a metal core is proposed, this ring traveler being characterized by a coating of an anti-friction coating on the metallic core. The anti-friction coating consists of at least one base polymer and one solid lubricant.

Anti-friction coatings are known from the prior art and form a subgroup with various possibilities of dry lubrication. The structure and processability of an anti-friction coating are similar to those of industrial paints with differences in such components as the solid lubricant, the binder (organic or inorganic resin) and the solvent (organic or water-miscible). Other ingredients may include, for example, fillers (pigments) or additives (corrosion inhibitors). For example, WO 2015/090597 discloses a solvent-free anti-friction coating based on polyamide imide and its use for coating metallic surfaces.

It has now surprisingly been found that coating a ring traveler with an anti-friction coating results in an improvement in the anti-friction properties of the ring traveler on the spinning ring during the initial and start-up phase of the spinning machines as well as leading to a definite increase in the lifetime of the ring traveler on the spinning machine. The anti-friction properties of untreated or thermally aftertreated ring travelers or ring travelers aftertreated by thermal diffusion methods or ring travelers provided with metallic or nonmetallic protective layers, such as nickel or ceramic, can be improved significantly. There is surprisingly only minor abrasion of the anti-friction coating during the initial spinning phase and the high-speed phase, despite the great mechanical stresses. The anti-friction properties of the ring traveler on the spinning ring during the initial spinning phase and the high-speed phase are improved by the anti-friction coating. Then the friction between the ring traveler and the spinning ring is reduced due to the resulting fiber lubricant film. It has been found that the anti-friction coating that is applied will not be damaged during the initial spinning phase or the high-speed phase due to these operating conditions even at the high rotational speeds of the ring traveler that prevail in ring spinning machines on the stationary spinning ring. In today's ring spinning machines, the ring traveler moves over the surface of the spinning ring at a speed of more than 45 m/s.

The anti-friction coating is preferably applied to the ring traveler in a drum spraying process or by immersion centrifugation. After the anti-friction coating has cured, a thin dry layer of lubricant adhering well to the metallic substrate is obtained. The anti-friction coating forms a thin friction-reducing and wear-reducing layer of lubricant after being applied and cured. This layer is dry, adheres to the metallic surface and cannot drip off. Any soiling of surrounding surfaces, as is the case with an oil or grease lubricant, can thereby be ruled out. This is an advantage in particular in the case of ring travelers in ring spinning machines, because soiling of the yarn during the spinning process has a negative effect on the quality of the spinning and further processing.

The anti-friction coating is characterized by a very thin, tightly adhering layer on the lubricating surface. Protective layers of 0.1 μm to 50 μm are preferred here. Thicker layers do not improve the anti-friction effect but instead merely result in a larger amount of coating material being sheared off during the spinning process, which may have a negative effect on soiling of the yarn. If the layer is less than 0.1 μm thick, the anti-friction coating may not have any effect at all, and the result will not be an improvement in the anti-friction properties in comparison with uncoated ring travelers. It has been found that a coating with a layer thickness of 0.5 μm to 10 μm results in optimization of friction values and lubrication properties, in particular in comparison with the usual wear-resistant layers, such as, for example, a thermal diffusion treatment or a metallic or nonmetallic coating. Due to the optimized layer thickness of the anti-friction coating, shear stresses occurring within the layer during the initial and start-up phase are reliably transferred from the anti-friction coating and the transition to the base material, and the anti-friction coating remains adhering to the metallic surface despite the high stress.

In a preferred embodiment, an additional coating or surface treatment is provided between the metallic core and the anti-friction coating. This serves to improve the thermal resistance, the dimensional stability and the corrosion resistance, among other things. For example, heat treatments, such as hardening or tempering, metallic coatings such as nickel plating, or nonmetallic coatings such as ceramics may be used here.

The base polymer is from the group of polyamides, polyimides, polyamide/imides. It has been found that this group of polymers yields good adhesion of the anti-friction coating to the metallic surface and supplies the required thermal stability. In a preferred embodiment, the solid lubricant is also preferably chosen from the group of organic or inorganic solid lubricants, polymeric solid lubricants, polyfluorinated compounds, graphite, metal sulfides, calcium phosphates, silicates and layered silicates.

It is particularly advantageous when the anti-friction coating contains metallic nanoparticles, for example, molybdenum, tantalum, tungsten). This yields an improvement in the wear properties of the anti-friction coating and permits efficacy of the anti-friction coating in repeated start-up processes of the ring traveler.

It has surprisingly been found that a ring spinning machine equipped with ring travelers according to the invention has a significantly improved behavior in the initial and start-up phase. There is therefore a definite increase in the lifetime of the ring travelers and there is also an increase in the possible speed of the ring travelers in the spinning process with no change in the good quality of the yarn or in the number of thread breaks. An improvement in yarn quality and a reduction in the incidence of yarn breaks can be achieved in particular in the initial and start-up phase.

The invention is explained in greater detail below on the basis of the drawings, in which:

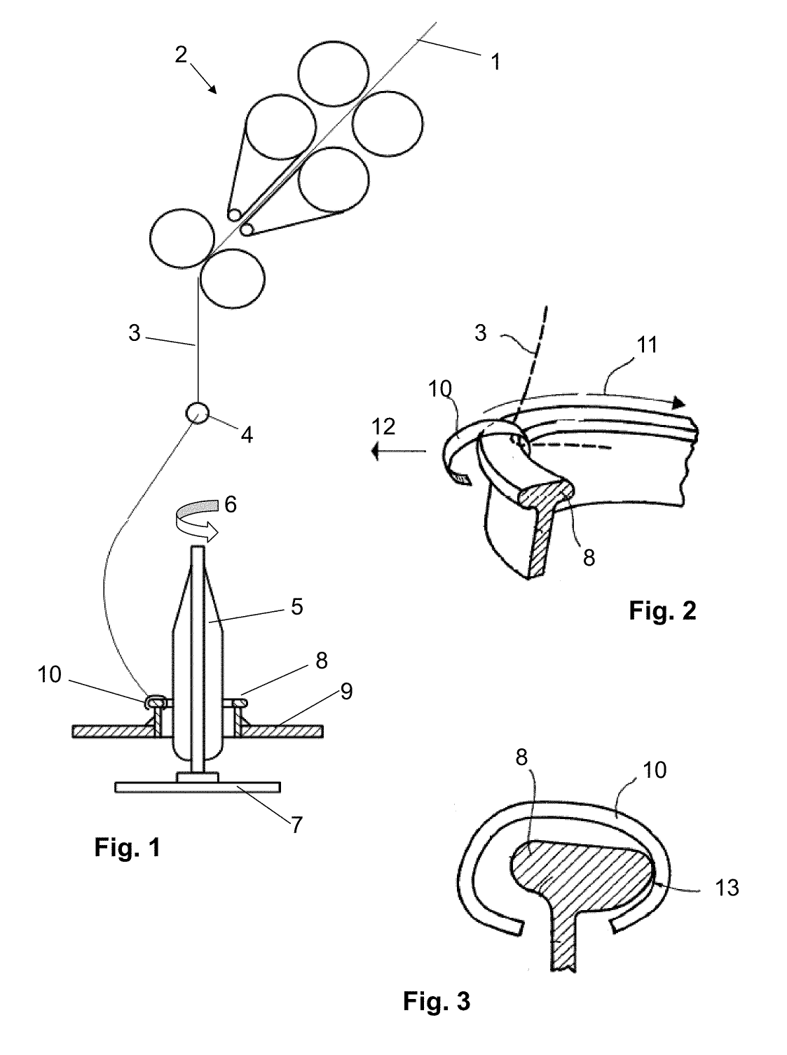

FIG. 1 shows a schematic diagram of a ring spinning machine,

FIG. 2 shows a schematic diagram of a spinning ring with a ring traveler,

FIG. 3 shows an enlarged diagram according to FIG. 2.

FIG. 1 shows a schematic diagram of a spinning position of a ring spinning machine, such that today's ring spinning machines have up to 2,000 such spinning positions. A fiber strand, a so-called sliver 1, is sent to a drawing unit 2 in the ring spinning machine. The sliver 1 is drawn by the drawing unit 2 to form a thread 3. The drawing unit 2 shown here is a so-called belt drawing unit, which is generally used for cotton. Depending on the application, a variety of designs for drawing units 2 are known from the prior art. The thread 3 is guided to a ring traveler 10 via a thread guide 4 downstream from the drawing unit 2. After passing through the ring traveler 10, the thread 3 is wound onto the yarn bobbin 5. The yarn bobbin 5 is set in rotation 6 by a drive 7. The ring traveler 10 is entrained by the thread 3 due to this rotation 6, which results in a twist being imparted to the thread 3, which thus forms the yarn. Due to the fact that the ring traveler 10 is held on the spinning ring 8, the ring traveler 10 is forced to travel around the yarn bobbin 5. The spinning ring 8 is held in a stationary amount on a ring frame 9.

When a full yarn bobbin 5 is replaced, the thread 3 remains looped through the ring traveler 10. The process begins again when a new yarn bobbin 5 has been inserted. At the beginning of a so-called initial spinning phase, the ring traveler 10 is to be accelerated by the thread 3. In this initial spinning phase, thread breaks occur frequently due to excessively high forces, which act on the thread 3 because of the required acceleration.

In a schematic diagram, FIG. 2 shows a spinning ring 8 with an attached ring traveler 10. The twist transferred to the ring traveler 10 via the thread 3 causes the ring traveler 10 to rotate about the spinning ring 8 in the direction of rotation 11. This rotation in turn causes a centrifugal force 12, which acts on the ring traveler 10 and forces the ring traveler 10 against the inside of the spinning ring 8. This situation is illustrated on an enlarged scale in FIG. 3, where the ring traveler 10 slides along the spinning ring 8, resulting in a sliding surface 13. At least in the area of this sliding surface 13, it is necessary to ensure that the ring traveler 10 has good anti-friction properties with respect to the spinning ring 8. The frictional forces that occur in particular during the initial spinning phase with acceleration of the ring traveler 10 from a standstill can be reduced by coating the ring traveler 10 with an anti-friction coating, at least in the high-stress region 13.

1. A ring traveler (10) for ring spinning machines or ring twisting machines, having a metallic core, characterized in that the metallic core is coated at least partially with an anti-friction coating consisting of at least a base polymer and a solid lubricant, whereby the anti-friction coating has a layer thickness of 0.1 μm to 50 μm and the base polymer is from the group of polyamides, polyimides, polyimide/imides.

2-8. (canceled)
